(19) United States
(12) Patent Application Publication
(10) Pub. No.: US 2017/0164649 A1
(43) Pub. Date: Jun. 15, 2017

(54) METHOD FOR SEPARATING THE SHELL FROM SEEDS OR FRUIT, SIFTING DEVICE, AND SELECTION DEVICE

(71) Applicant: INNO ALMOND FLY, S.L., Lleida (ES)

(72) Inventor: Salvatore LA CAGNINA, Riesi (IT)

(21) Appl. No.: 15/308,201

(22) PCT Filed: Nov. 28, 2014
(86) PCT No.: PCT/ES2014/070877

§ 371 Date: Nov. 1, 2016

(30) Foreign Application Priority Data
May 2, 2014 (ES) P201430642

(51) Int. Cl. A23N 5/08; A23L 7/10; B02B 3/00; A23N 4/02

(52) U.S. Cl. CPC A23N 5/08; A23N 4/02; A23L 7/10; B02B 3/00; A23N 5/008

(57) ABSTRACT

Procedure for separating the husk from the seeds or fruit, screening device and selection device

It comprises introducing the seeds or fruit in a splitting machine that hits said husk of the seeds or fruit, splitting it.

Procedure for separating the husk of seeds or fruit, screening device and selection device of the type comprising: a first stage wherein the seeds or fruit are fed into a splitting machine, that hits said husk of the seeds or fruit breaking it, characterised in that it comprises: a second stage wherein said split seed or fruit husk is transported inside at least one first separator or rotary, tubular screen, with walls having perforations for passing the husk-less seed or fruit and retaining the seeds and fruits with husks and the non-split seeds and fruit inside the separator, a third stage wherein the said first separator, rotates, moving the products inside it, with some of said products passing through said V-shape perforations or a combination thereof, falling in some collection means, and a fourth stage wherein the husks, the fruit and the seeds that have separated from the husk and the fruit and seeds with husks are transported from the collection means to at least one device comprising a slope along which said products fall, with said slope ending in a curve with a corrugated area and a point of inflection that guides it upwards to a trampoline where said products take off, with said husk-less seeds or fruit falling in respective classifying elements on one side, the seeds or fruits with husks on the other and the loose husks on another based on the friction coefficient of said products with the corrugated area.

### BACKGROUND TO THE INVENTION

In the state of the art different procedures and machines are known that separate the seed husk in dried fruit.

In the state of the art Utility Model ES1602627 MAQUINA EXTRACTORA-SEPARADORA DE PALOS U OTROS ELEMENTOS DE DESECHO”(Extraction-separating machine for stalks or other waste elements), in the name of JOSE BORRELL, S.A., which relates to an extraction-separating machine for stalks or other waste elements, particularly for separating a certain fruit, such as almonds or others of a similar nature, with respect to the stalks, branches, stones or other strange elements that accompany the fruit when it is harvested, characterised in that it comprises a frame at each end of which it incorporates a transverse axis with each transverse axis having a toothed wheel on each side each associated to one of the ends thereof, with the wheels of one same side being coplanar and mutually aligned with one another, extending between the toothed wheels on each side a chain which is susceptible to movement by virtue of the movement transmitted by the rotation produced by a geared motor unit in one of said transverse axes, and both chains including, in equidistant positions with respect to the inner faces thereof, a plurality of bearings coupled with transverse bars that can turn with respect to their axis, each of which including a plurality of orthogonal, equidistant rods along its length, and with said rods being of a length such that when they move across the top plane, they rest due to gravity on the transverse bar immediately behind according to the direction of movement, determining sufficient apertures to let the fruit fall towards a bottom collection hopper, but retaining the stalks and other strange elements, and moving to a vertical position due to gravity after passing the machine exit end, thanks to the rotation of the bars, favouring the fall of the entrained waste elements.

Also Spanish Patent No. ES2127070 “MAQUINA LIMPIADORA DE CUERPOS EXTRAÑOS PARA ALMENDRAS Y OTROS FRUTOS SECOS” (Machine for cleaning foreign bodies for almonds and other dried fruit) is known, in the name of Mr. José BORRELL COLLADO, which relates to an almond cleaning machine, provided with a framework, with the top area for the product entry, supported by the sides, with a screen at the bottom, for soil to fall onto a lower ramp that communicates with the duct outside, and the almonds falling along the ramp inside the separator, the bottom of which is made up of the special characteristics screen, adopting a tilted upflow plane and cushion of air, produced by the turbine, in which axis, the assembled transmission is provided from the drive motor, producing pressurised air within the area, with the stones and strange objects rising and falling through the adjustable flap and the clean almonds along the previous ramp, with the turbine taking the air, through the side nozzles, with the separator working, via the motor, pulleys, transmission to the pulley, applied to the part, for movement, with springs for the separator function.

It is worth mentioning a patent in the olive sector, but whose machinery could be highlighted as Spanish Patent No. ES2003018 “MÁQUINA LIMPIADORA DE ACEITUNAS MEJORADA” (Improved olive cleaning machine), in the name of Mr. Ildefonso ROSA RAMIREZ, which describes an olive cleaning machine, intended for separating and removing the waste accompanying said fruit and which is provided, essentially, with a framework that has an olive supply hopper and respective trays for the falling impurities. The cleaning machine comprises essentially respective vibratory separators that move simultaneously with the trays for the falling impurities and which are fixed to the machine framework by corresponding crankpins, respective turbofans for expelling waste with separate force transmission mechanisms, which provide movement to said turbofans through a series of pulleys with corresponding belts and an air baffle arranged near the fruit exit nozzle with an alternating movement and arranged with a variable and critical tilt.

From INDUSTRIAS JUAN BUSQUETS CRUSAT, S.A. there is Spanish Patent No. ES2069457 “MÁQUINA SEPARADORA DE CÁSCARA DEL GRANO DE ALMENDRA, FRUTOS SECOS Y GRANOS SIMILARES ” (Machine for separating the husk from the almond kernel, dried fruit and similar seeds), which relates to a machine that is made up of a tray in a tilted arrangement with a slope towards the exit, there being a raised end section of such tray and a higher one from its front or top edge to its rear or lower exit edge; there being arranged in correspondence with the fruit reception area some air outlet holes for turning the husks, while in correspondence with the higher side edge a duct has been provided with a plurality of elongated slots in the transverse direction, through which air is projected that separates the husks from the seeds, with the husks exiting through an exit mouth away from the exit mouth for the clean seed; said tray is assembled via its front edge on a frame that is supported via elastic supports on a second frame made up of the general framework, with an adjustable vibrator being arranged on the first frame.

Finally it is worth mentioning Spanish Utility Model No. 1011082 “CRIBA SELECCIONADORA ROTATORIA DE DESCARGA LIBRE ADAPTADA A MAQUINAS RECOLECTORAS DE FRUTA SECA DEL TERRENO” (Selective, rotary screen with free discharge adapted to harvesting machines for dried fruit from the land), in the name of TONUTTI, SPA, which describes a selective, rotary screen with free discharge adapted to harvesting machines for dried fruit from the land, characterised by the fact that it is made up of two coaxial cylinder-sieves, joined to one another and arranged horizontally, there being on each inner side surface thereof at least one helicoidal rib for facilitating the advance of the harvested material, which is introduced through the base of the innermost cylinder-sieve and expelled through the opposite base as waste, while the fruit is expelled in the same direction, but from the outer cylinder-sieve, which has at least two circumferential outer notches separate from one another, preferably trapezoidal, inside which some pulleys move, some intended to support the whole screening and one at least located opposite the former, with an appropriate spring adjustable transmission intended to transmit the rotary movement to the screen: when the latter is rotated, with a double coaxial sieve and the harvested material is inserted through the base of the innermost sieve, the product is driven over the respective side walls and, once selected, it is pushed towards the discharge on the side opposite the entrance.

### BRIEF DESCRIPTION OF THE INVENTION UNDER APPLICATION

This invention is a development in the field of separating seeds or fruit with husks, such as for example, dried fruit, locust beans, cereals, pulses, etc., (this is not an exhaustive list as indicated later).

It is necessary to note that the list of dried fruit products with a husk, seeds, locust beans or pulses is non-limiting, because as can be seen both the procedure and both devices can be applied to a large number of agricultural products. Also, when reference is made to seeds it is to group them all under one name, unless it is clearly understood that reference is made strictly to seeds.

The inventor has developed a new procedure for separating the seed or fruit from the husk, based also on two devices that help this task.

So, at present the sector develops by improving the machinery electronics, i.e., manufacturing increasingly smarter machines that depend on electronics and this makes the product more expensive and not feasible for many small and medium businessmen.

This way, the inventor has developed a procedure and some devices that are based on mechanical means, i.e., productivity is increased, costs are reduced because the unit is much more economical, energy consumption is reduced by 50%, the emission of dust from the husks is reduced, the noise produced by the current machines is reduced by 60%, and the surface area occupied by the machine is reduced, etc., which makes this invention a substantial qualitative leap with respect to the state of the art.

Also, as the product resulting from the procedure has moved or been shifted less, there are less stages than the resulting product obtained from the state of the art procedures, its quality is better, which makes it an excellent quality product. It is particularly worth mentioning that the product is not pricked at any time, whereby the quality of the end product is much better than many of the machines offered today.

Also, the current electronic machines have to be updated or renewed every four or five years, because they become obsolete, while the current invention will hardly become obsolete because the electronic means do not directly affect the separation process.

Document ES1011082 comprises a cylindrical, rotary screen that aims to allow those products with a certain size to pass through its screen. The problem is that when screening for a certain size many small size husks can enter.

This invention solves these problems with the configuration of “V” shaped perforations or a combination thereof which allows the non-split husks or fruit to remain trapped in the curves or angles, and at the same time lets the seeds pass through.

A first objective of this invention is a procedure for separating the husk of seeds or fruit, of the type comprising: a first stage wherein the seeds or fruit are fed into a splitting machine, that hits said husk of the seeds or fruit breaking it, characterised in that it comprises: a second stage wherein said split seed or fruit husk is transported inside at least one first separator or rotary, tubular screen, having walls with perforations for passing the husk-less seed or fruit and retaining the seeds and fruits with husks and the non-split seeds and fruit inside the separator, a third stage wherein the said first separator, rotates, moving the products inside it, and with some of said products passing through the said V-shape perforations or a combination thereof, falling in some collection means, and a fourth stage wherein the husks, the fruit and the seeds that have separated from the husk and the fruit and seeds with husks from the collection means are transported to at least one device comprising a slope along which said products fall, with said slope ending in a curve with a corrugated area and a point of inflection that guides it upwards to a trampoline where said products take off, with said husk-less seeds or fruit falling in respective classifying elements on one side, the seeds or fruits with husks on the other side and the loose husks on another based on the friction coefficient of said products with respect to the corrugated area.

A second objective of this invention is a screening device for products like seeds or fruit with husks, of the type comprising at least one separator or screen, with a tubular configuration, that defines an inlet and an outlet from said separator, rotation means on the transverse axis of the separator, perforations in the tubular wall for passing or screening the product and collection means for the screened product, characterised in that the said perforations have a V-shape or combination thereof.

A third objective of this invention is a selection device for products like dried fruit with husks, seeds or pulses, of the type comprising a slope where the husk-less seeds, the seeds with husks and husks fall, characterised in that it comprises: a curve at the end of the slope comprising: a point of inflection that changes direction lifting the product, and at least one corrugated area, a trampoline where the said products jump, and some classifying means that classify the products that jump from the trampoline.

### BRIEF DESCRIPTION OF THE DRAWINGS

In order to facilitate the explanation, this specification is accompanied by ten sheets of drawings wherein a practical embodiment has been represented, which is quoted as a non-limiting example of the scope of this invention:

FIG. 1 is a perspective view of a screening device,

FIGS. 1b and 1c are respective details of the mesh of said device,

FIG. 2 is an elevation view of FIG. 1 without the mesh with the perforations,

FIG. 3 is a cross-section of FIG. 1,

FIG. 4 is a partially broken down detail of one of the separators,

FIG. 5 is a perspective view of the selection device,

FIG. 6 is a cross-section of the selection device,

FIG. 7 is a cross-section of the selection device with the fan-shape classifiers,

FIG. 8 is a partial view of FIG. 6 but with two selection devices,

FIG. 9 is a rear partial view of the slope, and

FIG. 10 is a detail of the slope supply device.

### SPECIFIC EMBODIMENT OF THIS INVENTION

First of all it is necessary to note that the list of dried fruit products with husks like almonds, hazelnuts, walnuts, pistachios, macadamia nuts, Brazil nuts, etc.; seeds of every kind like cereals, sunflower, apricot seeds, etc.; locust beans; or pulses of every kind, is non-limiting because as can be seen both the procedure and both devices can be applied to a large number of agricultural products.

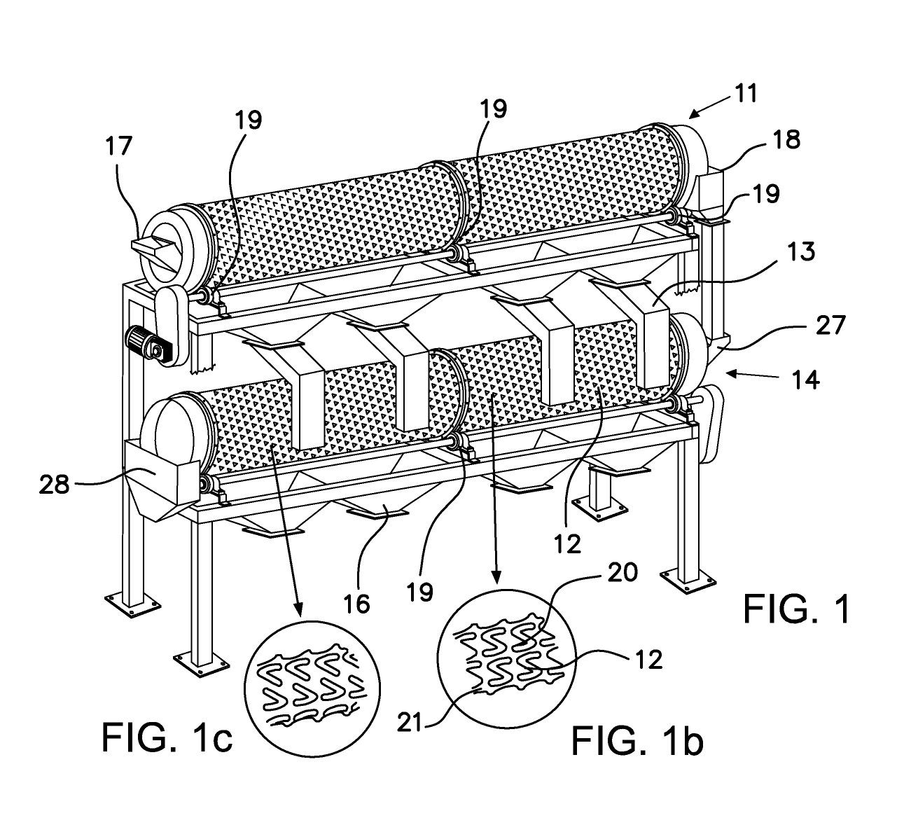

FIG. 1 shows a first separator 11, with its rotation means 19, an inlet 17, an outlet 18, collection means 13, a second separator 14, an inlet 27, an outlet 28, rotation means 19 and its collection means 16.

FIGS. 1b and 1c represent a mesh 21, the perforations 12 and some inner projections 20.

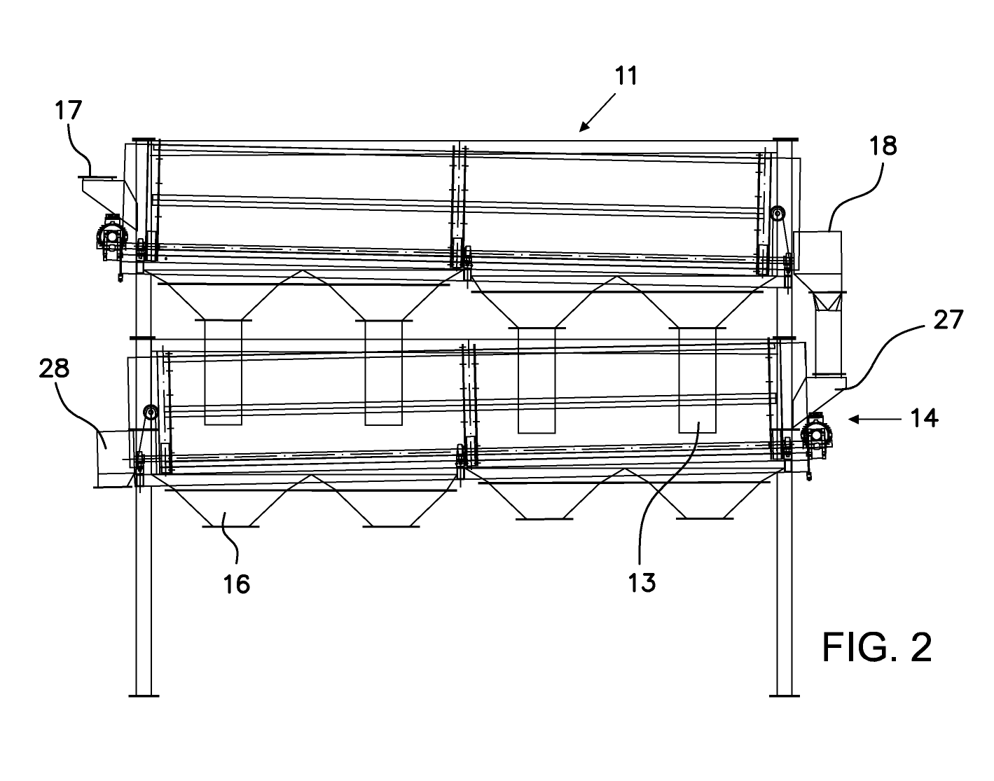

FIG. 2 illustrates the first separator 11, its inlet 17, its exit 18, the collection means 13, the second separator 14, its inlet 27, its exit 28 and its collection means 16.

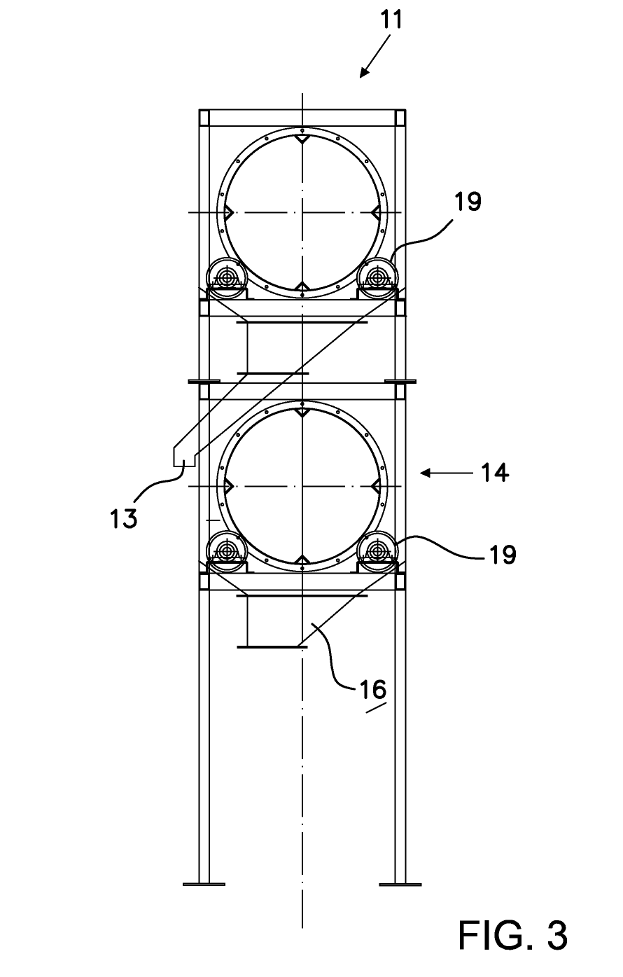

FIG. 3 illustrates the first separator 11, its rotation means 19, the collection means 13, the second separator with its rotation means 19 and the collection means 16.

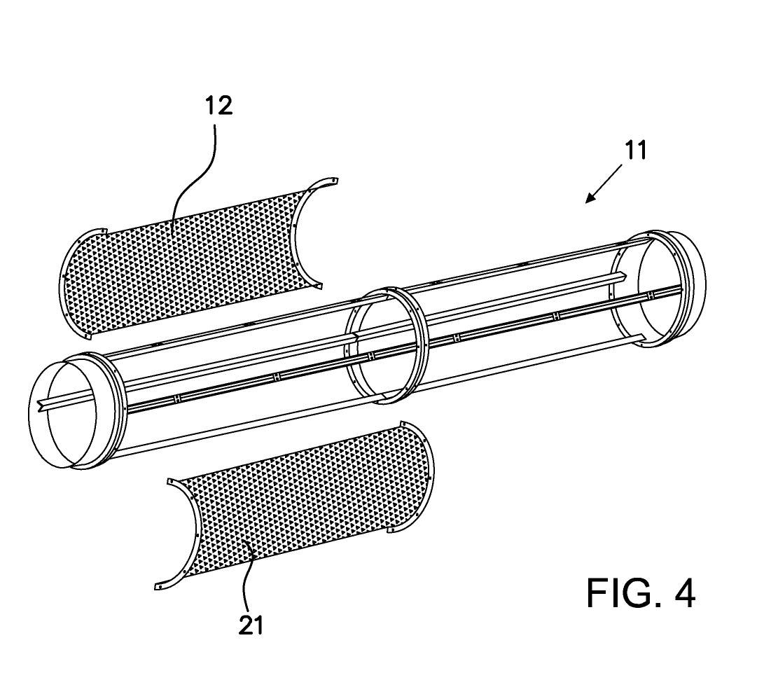

FIG. 4 shows the first separator 11 with the perforations 12 in a mesh 21.

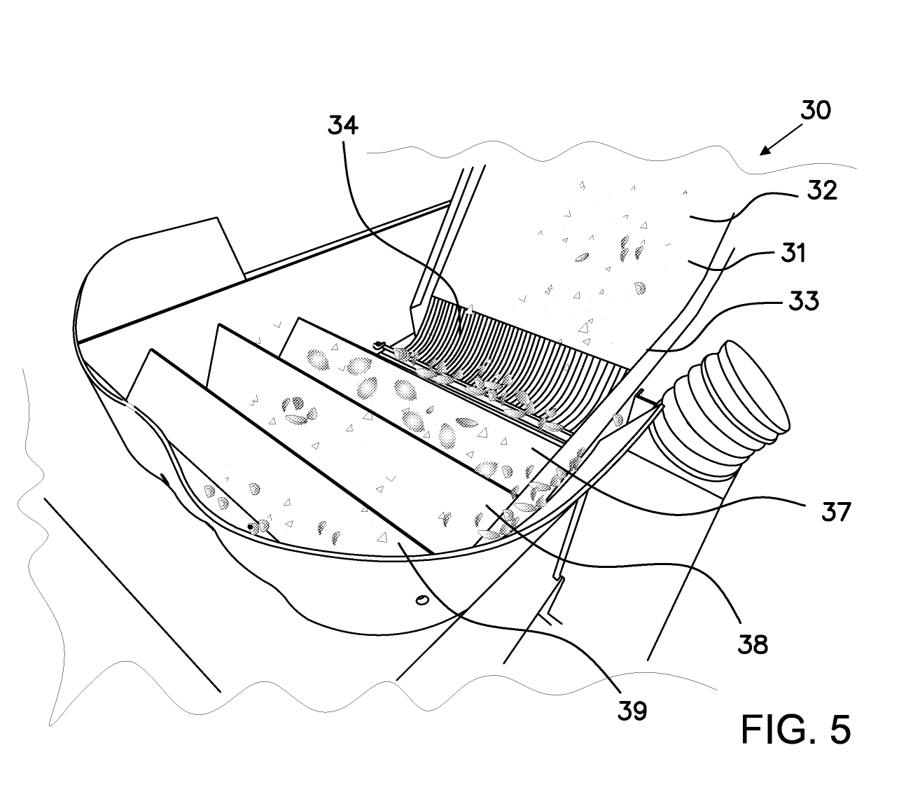

FIG. 5 shows a selection device 30, a slope 31, products 32, a curve 33, a corrugated area 34 and classifying means 37, 38, 39.

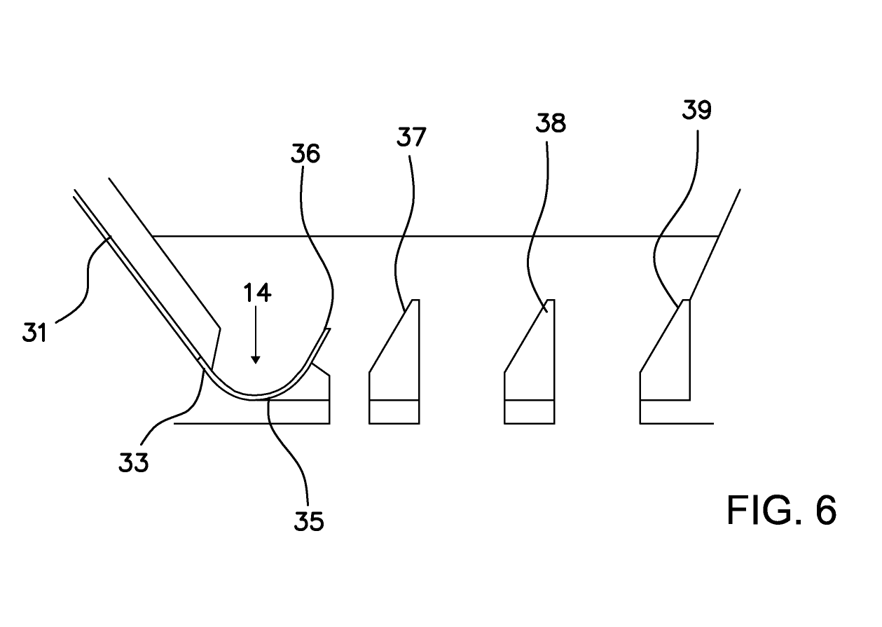

FIG. 6 shows the slope 31, the curve 33 with its point of inflection 35, the corrugated area 34, a trampoline 36 and the classifying means 37, 38, 39.

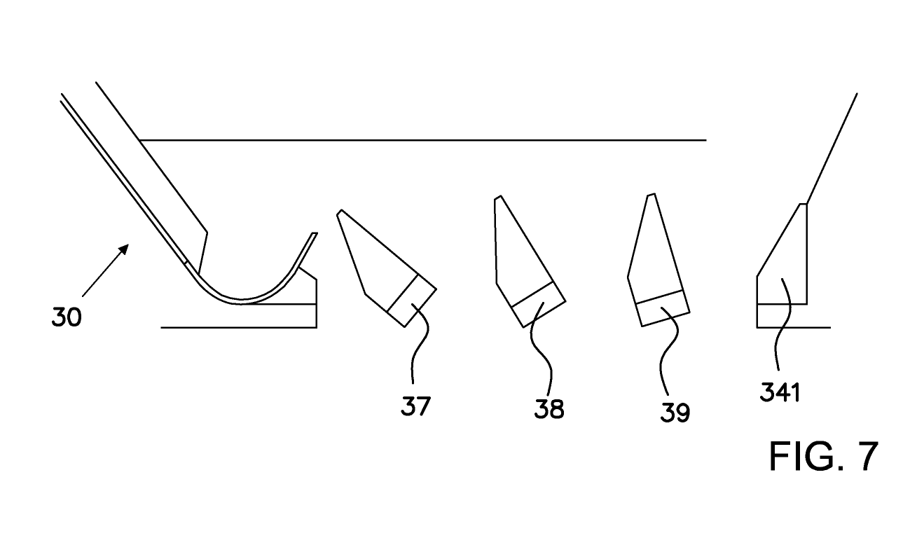

FIG. 7 shows the selection device 30, the classifying means 37, 38, 39, 341.

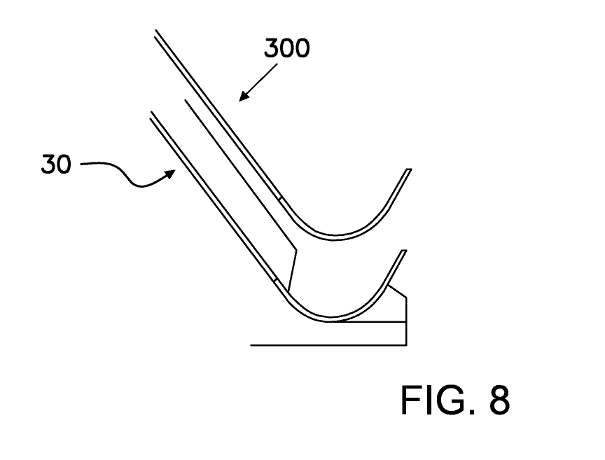

FIG. 8 shows the selection device 30 and a second selection device 300.

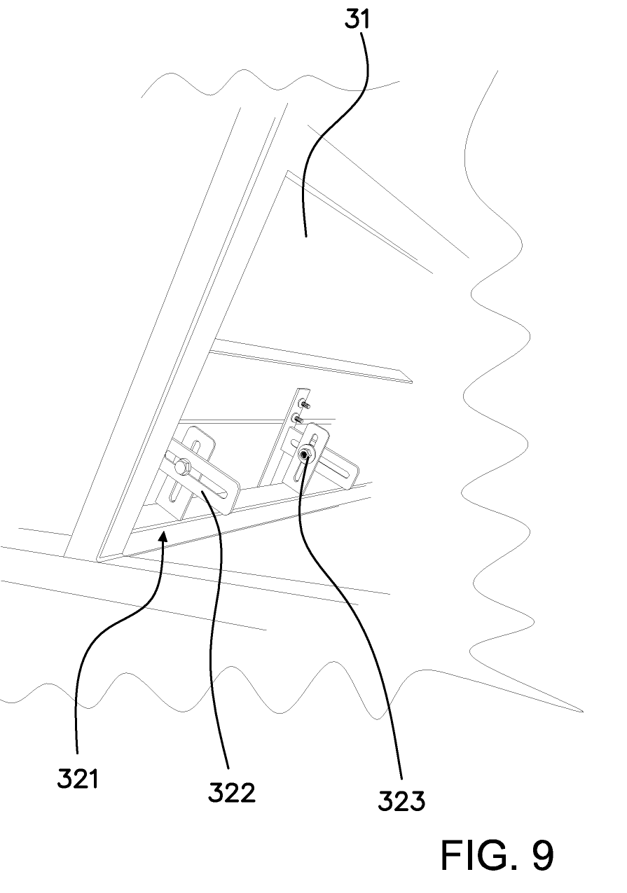

FIG. 9 shows the slope 31, adjustment means 321, a splint with guide 322 and a passing system 323.

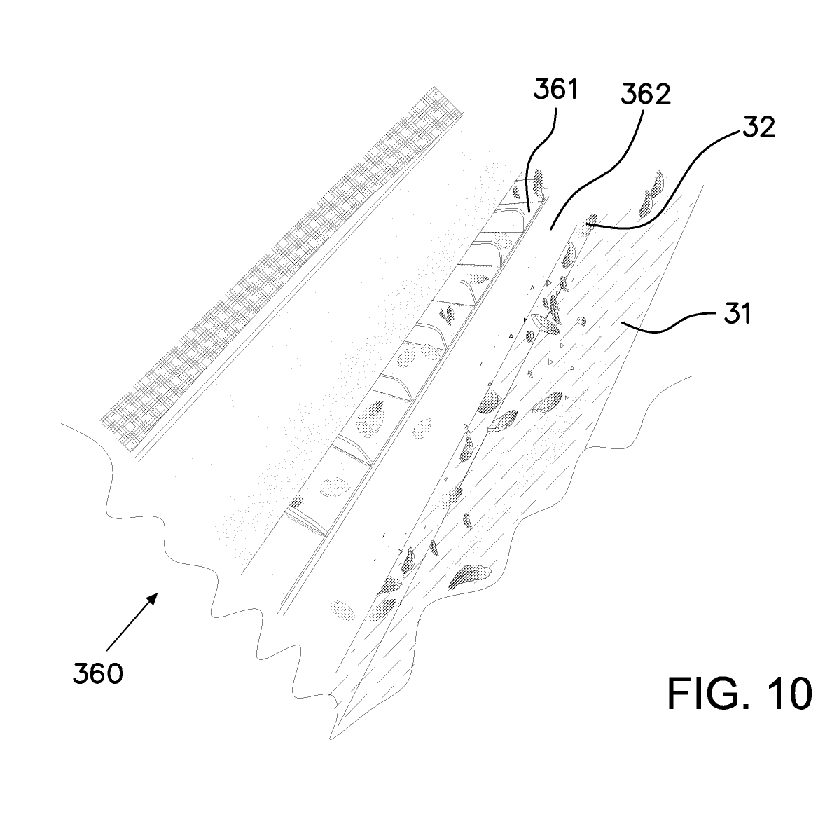

Finally, FIG. 10 illustrates the slope 31, products 32, supply means 360 with its supply channels 361 and a splint 362.

So in a specific embodiment of the invention, it relates, only as an example, to dried fruits, for example almonds, but it is not limited thereto, because as mentioned earlier, it can be applied in general to seeds and fruit with husks.

The procedure for separating the husk from the seed in dried fruit comprises a first stage wherein the dried fruit is fed into a splitting machine, which hits said dried fruit husk to split it.

Also it comprises a second stage wherein said dried fruit husk is transported, most of it split, into at least one first separator 11 or rotary, tubular screen. In this embodiment there are two separators 11, 14, even though there could be just one or more than two, depending on requirements (type of product) and the production units assembled.

The walls of separator 11 comprise perforations 12 for passing the husk-less seeds and retaining the seeds with husks and the non-split fruit inside separator 11.

As can be seen in FIG. 4, said perforations 12 can be made like a mesh 21, removable, this way it can be changed, repaired and cleaned.

In a third stage the said first separator 11, rotates, moving the products inside it, and with said seeds passing through said perforations 12 having a basic V-shape or modifications thereto such as (as a non-limiting list) “S”, “N”, “W”, “M”, “2”, “1”, “L” or variations or combinations thereof, and falling in to collection means 13.

The perforations with a basic V-shape, for example in this embodiment in “S” or “N”, or their mirror image, make it possible to select in one single screening up to four different sizes of dried fruit, improving up to 80% the procedures used at present.

In this specific embodiment the “N” or “S” shape is chosen, as shown in FIG. 1b, although as mentioned earlier, the objective covers perforations that contain a V-shape or variations or modifications thereof, as in the list indicated two paragraphs above.

In the fourth stage, the husks that have been filtered, the fruit or seeds that have separated from the husk and the seeds with husks that have managed to pass to the collection means 13 are transported to a selection device 30 which comprises a slope 31 along which said products 32 fall, with said slope ending in a curve 33 with a corrugated area 34 and a point of inflection 35 that guides it upwards to a trampoline 36 where said products 32 take off, landing in respective classifying elements 37, 38, 39 said husk-less seeds on one side, the seeds with husks on the other and the loose husks on another based on the friction coefficient of said products 32 with respect to the corrugated area 34.

This fourth stage can comprise a series of previous, intermediate stages for returning the non-split fruit to the initial splitting machine, or for screening with vibration devices so that more material without superfluous husks are delivered, etc.

So, optionally, between the third and the fourth stage there is a third intermediary stage wherein the products 32 that remain inside the first separator 11 are transferred to a second separator 14 or rotary, tubular screen with identical or similar characteristics as the first separator 11, for passing the husk-less seeds and retaining the seeds with husks and the non-split fruit inside the separator 14, comprising said “S” or “N” shape perforations 12.

Optionally, the separators 11, 14 can be tilted towards the floor, this facilitates the advancement of the products 32 (FIG. 2).

The separators 11, 14 or tubular screens in this embodiment are cylindrical, even though they could have another more quadrangular shape, for example, depending on requirements.

The screening device for products like dried fruit with husks, an objective of the invention, comprises at least one separator 11 or screen, with a tubular configuration, that defines an inlet 17 and an outlet 18 of said separator 11, rotation means 19 on the transverse axis of the separator, perforations 12 in the tubular wall for passing or screening the product and collection means 16 for the screened product, with said V-shape perforations 15 or combinations thereof, as explained before. As in the procedure, the chosen shape is “N” or “S”, even though any V-shape or modifications thereof can be used.

Said shape, and its respective mirror representations, as mentioned earlier, allow for better filtering of products 32, virtually retaining all the non-split fruit and many of the split fruit that is stuck to the seed.

Also the inventor has seen that if the inner projections 20 of the V-shape perforations are rounded the effectiveness of the perforations is greatly improved.

The inventor has tested that said V-shape figure has a husk breakage effect, which translates into splitting any half split husks, which increases the result of the first stage (split husks) by at least 30%.

This also leads to a very noticeable reduction in energy consumption, as it is not necessary to return many husks, and in the time used to obtain a certain amount of the end fruit, which leads to greater quality of said end product, as said product is in the machine for less time.

As shows in FIGS. 1 to 4, the device optionally can comprise a second separator 14 or screen.

Said separator 14 would be located under the first separator 11, with transport means connecting the outlet 18 from the first separator to the inlet 27 of the second separator, transporting the products from inside the first separator 11 to inside the second separator 14, to continue the screening.

Both the first 11 and the second 14 separators can have at their exit 18, 28 means for returning the product from the inside, either to another device, such as the splitting machine, or to a previous separator inlet 17, 27.

To facilitate the advance movement of the products inside separators 11, 14, said separators are optionally tilted towards the floor.

The selection device of products like dried fruit with husks, seeds, locust beans or pulses, comprises a slope 31 along which the husk-less seeds, the seeds with husks and the husks 32 fall.

It comprises a curve 33 at the end of the slope 31 that comprises, in turn, a point of inflection 35 that changes the direction of the curve 33 lifting the products 32, and at least one corrugated area 34.

The curve 33 ends in a trampoline 36 on which the said products 32 jump.

Also, the device comprises classifying means 37, 38, 39 that classify the products that jump from the trampoline 36.

The corrugated area 34 allows the husk, as it has a smoother surface, when it jumps on the trampoline 36, to reach greater acceleration and fly to classifiers 38, 39 further away from the trampoline 36.

On the contrary, the husk-less dried fruit, has a rough skin, which means that when it comes into contact with the corrugated area 34, its acceleration is reduced due to the friction and once it abandons the trampoline 36, it hardly flies, and therefore falls into the closer classifiers 37.

Depending on the type of product 32, it is possible to change the height and the angle of the trampoline 36, i.e. said trampoline 36 is adjustable, which gives it great versatility and adaptability.

Along the same lines, it is possible to adjust the angle of the slope 31 via adjustment means 321, for example a splint with a guide 322 and a passing system 323, thereby adjusting the acceleration of the fruit and the husks, increasing or reducing it by moving said angle (FIG. 9).

Also, depending on the product 32, it is possible that both the trampoline 36 and the slope 31 have extension means, to increase or reduce the speed of the product 32.

Also, to adapt to the possibilities of extensions and the different products 32, the classifying means 37, 38, 39 are movable, so that their width and position can change in the device. In other words, both the space between the classifiers 37, 38, 39, 341 can be changed and their angle, adopting a more vertical configuration as shown in FIG. 6 or in the shape of a fan as shown in FIG. 7.

The inventor has noticed that after the working day, it is possible that on the trampoline 36 and on the curve 33, mainly, there may be some impurities, like dust or some small waste from the husks. This could affect the friction and therefore the classification of product 32 in the classifying means 37, 38, 39.

So, means have been designed for cleaning the trampoline 36, which could be a brush or blower means, for example.

Also, within the different construction options for the slope 31 and the trampoline 36, a sequence of different slopes 31 or trampolines 36 could be built, aided by very precise air suction that would assist both the device cleaning and the distribution of the various products in their selection process.

Another construction option is the possibility of having more than one selection device for products like dried fruit with husks, seeds or pulses 30, 300, as shown in FIG. 8, by placing one on top of another, so that space is optimised, and that production, this way, can be increased.

The material to use in constructing the slope 31, the curve 33 and the trampoline 36 can be very diverse, although in at least one part of the section of the slope 31, curve 33 or trampoline 36, in this specific embodiment, this material has to be a material with sliding, anti-friction properties. In other words, said material can be used in a section of slope 31, or of curve 33 or of trampoline 36, or in two of them, or in the three, or in the whole surface or in part thereof.

Said possibilities are marked by the products 32 that are used, and their different friction properties. So different devices 30 can be available depending on the friction properties of the dried fruit, for example, if different types of almond are used, each one could have its own device 30, because not all the varieties behave the same way.

In order to make sure that the product slides down the slope 31, the inventor has developed supply means 360 for said slope 31, which allow the products to fall one by one.

So, the supply means 360 comprise supply channels 361 that supply the product to a splint 362, in this embodiment tilted, even though it could not be, separated a certain distance from the slope 31, so that said distance is enough to allow the passage of product 32 through the same place.

Obviously, depending on the product 32 and if talking about almonds, the variety, said distance must vary, according to the sizes thereof, with means existing to approach or separate said tilted splint 362 from the slope 31.

The inventor, in this embodiment and without it being a limiting element, has used glass as the anti-friction sliding surface, where the products 32 slide both along the slope 31, and the curve 33 or the trampoline 36, even though said material could change, depending on the product 32 used and its need to accelerate and fly.

This patent of invention describes a new procedure for separating the husk from seeds or fruit, a screening device and selection device. The examples mentioned here do not limit the invention, as it can have different applications and/or adaptations, all within the scope of the following claims.

1-23. (canceled)

23. A method for separating husks from organic products, wherein the organic products include at least one of fruits or seeds, and wherein the method comprises:
feeding the organic products into a splitting machine that hits the husks, thereby separating the husks from only a portion of the organic products;
transporting the organic products and the separated husks, after said feeding the organic products into a splitting machine, inside a first rotary screen including perforations configured to pass husk-less organic products and the separated husks and further configured to retain husked organic products;
rotating the first rotary screen whereby the organic products are moved and the husk-less organic products and the separated husks pass through the perforations, thereby falling into at least one collection portion; and
transporting the husk-less organic products, the separated husks, and the husked organic products to at least one component comprising a downwardly sloped region followed by an upwardly curved region followed by a ramp, wherein at least a portion of the upwardly curved region or the ramp comprises corrugation, wherein:
the husk-less organic products, the husked organic products, and the husks travel down the downwardly sloped region and up the ramp, thereby becoming airborne;
the airborne husk-less organic products land in a first classifying portion;
the airborne husked organic products land in a second classifying portion; and
the airborne separated husks land in a third classifying portion.

24. The method of claim 23, further comprising subsequent to said rotating the first rotary screen, transferring the organic products and any remaining husks to a second rotary screen including perforations, whereby the organic products are moved and the husk-less organic products and the separated husks pass through the perforations, thereby falling into at least one collection portion.

25. The method of claim 23, wherein the first rotary screen slopes downwardly.

26. The method of claim 23, wherein the first rotary screen comprises a cylindrical shape.

27. A device for screening husked organic products, husk-less organic products, and separated husks, the device comprising:
a first rotary screen including an inlet, an outlet, and perforations;
a rotating portion located on a transverse axis of the first rotary screen;
wherein:
the perforations comprise a V-shape; and
the perforations are configured to pass the husk-less organic products and the separated husks, but not the husked organic products.

28. The device of claim 27, wherein inner projections the perforations are rounded.

29. The device of claim 27, further comprising:
a second rotary screen located beneath the first rotary screen, wherein the second rotary screen includes an inlet, an outlet, and perforations;
a transporting portion between the outlet of the first rotary screen and the inlet of the second rotary screen
wherein:
the perforations comprise a V-shape; and
the perforations are configured to pass the husk-less organic products and the separated husks, but not the husked organic products.

30. The device of claim 29, further comprising a component configured to return the organic products or the separated husks to a previous location in the processing line.

31. The device of claim 27, wherein the first rotary screen slopes downwardly.

32. A system for selecting organic products or husks, the system comprising:
a sloped region;
a curved region at following the sloped region, wherein the curved region includes:
a point of inflection where the direction of the curved region begins sloping upwardly; and
a corrugated region;
a ramp extending from the curved region;
a classifying section; and
wherein:
the system is configured such that the organic products with or without husks and the husks themselves travel down the sloped region, through the curved region, across the corrugated region, up the ramp, into the air, and into a particular area of the classifying section depending on whether an item is a husked organic product, a husk-less organic product, or a husk.

33. The system of claim 32 further comprising an additional device comprising:
an additional sloped region;
an additional curved region following the additional sloped region, wherein the additional curved region includes:
an additional point of inflection where the direction of the additional curved region begins sloping upwardly; and
an additional corrugated region;
an additional ramp extending from the additional curved region;
an additional classifying section; and
wherein:
the additional device is configured such that the organic products with or without husks and the husks themselves travel down the additional sloped region, through the additional curved region, across the additional corrugated region, up the additional ramp, into the air, and into a particular area of the additional classifying section depending on whether an item is a husked organic product, a husk-less organic product, or a husk.

34. The system of claim 32, wherein an angle of the ramp is adjustable.

35. The system of claim 32, further comprising a ramp extension.

36. The system of claim 32, wherein the classifying section is adjustable.

37. The system of claim 32, further including a component to clean the ramp.

38. The system of claim 37, wherein the component to clean the ramp comprises a brush.

39. The system of claim 37, wherein the component to clean the ramp comprises an air blower.

40. The system of claim 37, wherein at least one of the sloped region, the curved region and the ramp comprises a material that has anti-friction properties.

41. The system of claim 40, wherein the material comprises glass.

42. The system of claim 37, further comprising a component to adjust an angle of the sloped region.

43. The system of claim 42, wherein the component to adjust an angle of the sloped region comprises a strip with a guide and a passing system.

44. The system of claim 42, further comprising a supply region including at least one supply channel configured to supply the organic product to a splint that is positioned a distance from the sloped region, so that said distance is enough to allow the product to pass through the same place.

45. The system of claim 44, wherein the splint is tilted downwardly.
